(19) United States
(12) Patent Application Publication
(10) Pub. No.: US 2004/0163133 A1
(43) Pub. Date: Aug. 19, 2004

(54) Storing medium storing game program, game apparatus, action-range controlling method of game character

(75) Inventors: Kenshiro Ueda, Kyoto-shi (JP); Kenichi Nishi, Tokyo (JP)

Correspondence Address: NIXON & VANDERHYE, P.C., 1100 N. GLEBE ROAD, 8TH FLOOR, ARLINGTON, VA, 22201, US

(73) Assignee: Nintendo Co., Ltd., Kyoto (JP)

(21) Appl. No.: 10/771,319

(22) Filed: Feb. 5, 2004

(30) Foreign Application Priority Data
Feb. 10, 2003 (JP) 2003-32796

(51) Int. Cl. H04N 7/173; G06F 19/00; A63F 13/00; H04N 7/16; A63F 9/24; G06F 17/00

(52) U.S. Cl. 725/133; 725/142; 463/1; 463/40; 463/44

(57) ABSTRACT

A video game apparatus includes a CPU, and the CPU executes a game process of an RPG stored in an optical disk. The CPU refers to state data of a player possessing item (specific item) stored in a main memory, and when the state data of the specific item shows a predetermined state, an actionable time-period of a player character (leading character) in a game world is extended.

### BACKGROUND OF THE INVENTION

1. Field of the invention

The present invention relates to a storing medium that stores a game program, a game apparatus, and an action-range controlling method of a game character. More specifically, the present invention relates to a storing medium that stores a game program, a game apparatus, and an action-range controlling method of a game character adapted to a roll-playing game in which a player character acquires an experience value through various experiences in a virtual space of a game play, and achieves a final purpose.

2. Description of the prior art

Generally, in various video games, a genre of a game called as a roll-playing game (hereinafter referred to as “RPG”) is known. The RPG is a game in which a leading character (player character) operated by a player acquires an experience value by fighting a battle against an enemy character in a virtual space of a game play, and based on the acquired experience value, the player character expands an action range as a result of becoming stronger, thereby, achieving a purpose finally set.

PocketMonsters (trademark), which is an example of a prior art of this kind, for example, is a game software marketed by the present applicant, and in this RPG, by making a Pocket Monster (hereinafter referred to as “Pokemon” (Trademark)) owned by the player character fight against another Pokemon, the experience value (level) of the Pokemon owned by the player character is increased.

In addition, Ocarina of Time in The Legend of Zelda (Trademark), which is another example of the prior art, is a game software marketed by the present applicant. In this RPG, as a result of the player character obtaining a special item (specific item), the player character increases his own physical strength, and becomes more advantageous in the battle against the enemy character. Furthermore, by conquering an event of a specific level, the action range of the player character is expanded.

However, in the conventional RPG, the player character obtains the experience value by fighting a battle against the enemy character, and expands the action range by becoming stronger. That is, there are many RPGs intended to obtain the experience value by the battle.

In addition, as in the latter, although there are some RPGs intended to increase a physical value not by the battle but by obtaining the specific item, unless the physical value is increased, the player character does not become advantageous in the battle. Furthermore, unless the enemy character of the specific level is defeated, it is not possible to expand the action range.

Moreover, it is not possible for a user or a player who finds difficulties in fighting (not good at fighting) to exactly perform an appropriate operation, and therefore, it is not possible to increase the physical value and the experience value of the player character, thus not possible to expand the action range. As a result, it is not possible to easily enjoy the RPG.

### SUMMARY OF THE INVENTION

Therefore, it is a primary object of the present invention to provide a novel storing medium that stores a game program, a game apparatus, and an action-range controlling method of a game character.

It is another object of the present invention to provide a novel storing medium that stores a game program, a game apparatus, and an action-range controlling method of a game character capable of expanding an action range not by a fight, and increasing savor and amusement.

A storing medium that stores a game program according to the present invention is a storing medium that stores a game program of a game apparatus provided with an operating means for inputting operating information by a player, and facilitating a game by generating a game image corresponding to the operating information and displaying the game image on a display means, and the game program allows a processor of the game apparatus to execute following steps of: an item storing step; an elapsed time-period counting step; an actionable time-period setting step; a comparing step; an action restraining step; and an actionable time-period changing step. The item storing step temporarily stores an item possessed by a player character. The elapsed time-period counting step counts an elapsed time-period in a virtual space of a game play. The actionable time-period setting step sets an actionable time-period of the player character. The comparing step compares the actionable time-period set by the actionable time-period setting step and the elapsed time-period counted by the elapsed time-period counting step. The action restraining step disables an action of the player character when the elapsed time-period exceeds the actionable time-period. The actionable time-period changing step increases the actionable time-period when a specific item is temporarily stored by the item storing step.

According to the present invention, a game apparatus (12: reference numeral. Hereinafter, the same) is provided with an operating means (22, 26) for inputting operating information by a player, and facilitates a game by generating a game image corresponding to the operating information and displaying the game image on a display means (34). The game program stored in a storing medium allows a processor (36) of the game apparatus (12) to execute following steps. An item storing step (S11) stores an item possessed by a player character. An elapsed time-period counting step (S3) counts an elapsed time-period (404a) in a virtual space (game world) of a game play. An actionable time-period setting step (SI) sets an actionable time-period (404b) of the player character (82). A comparing step (S5) compares the actionable time-period (404b) of the player character (82) and the elapsed time-period (404a) counted by the elapsed time-period counting step (S3). An action restraining step (S7) disables an action of the player character (82) when the elapsed time-period (404a) exceeds the actionable time-period (404b). Furthermore, an actionable time-period changing step (S43) increases (extends) the actionable time-period (404b) when a specific item (84c) is temporarily stored by the item storing step (S11). That is, the actionable time-period changing step (S43) expands an action range of the player character.

In a certain embodiment, the actionable time-period changing step increases the actionable time-period in correspondence with the number of specific items stored by the item storing step. More specifically, the actionable time-period changing step (S43) increases the actionable time-period (404b) in correspondence with the number of specific items (84c) temporarily stored by the item storing step so that it is possible to expand the action range without depending on a battle.

In another embodiment, the item storing step includes an item-state storing step for temporarily storing item-state data showing states of each of said items, and the actionable time-period changing step increases the actionable time-period when the item-state data of the specific item shows a predetermined state. More specifically, the item-state storing step (S11) temporarily stores the item-state data (404d) showing states of each of the specific items (84c) so that it is also possible to extend the actionable time-period when the item-state data (404d) shows a predetermined state.

In a certain aspect, a storing medium further comprises a first-state changing step, and a second-state changing step. The first-state changing step changes a state of the specific item to a first state. The second-state changing step changes to a second state the specific item that is changed to the first state when a predetermined condition is satisfied. The actionable time-period changing step changes the actionable time-period in such a manner as to render longer when the specific item is changed to the second state. More specifically, the first-state changing step (S27) changes a state of the specific item (84c) to the first state. The second-state changing step (S37) changes to the second state the specific item (84c) that is changed to the first state when a predetermined condition is satisfied. The actionable time-period changing step (S43) changes the actionable time-period in such a manner as to render longer when the specific item (84c) is changed to the second state. That is, in a case of increasing the actionable time-period, the item-state data (404d) needs to be in a predetermined state such as the second state. Thus, it is necessary to change (transform) the state of the item so that it is possible to enhance a level of difficulties of the game, a fascinating aspect of the game, and etc.

In a certain embodiment, the specific item includes a first item and a second item that have a predetermined relationship. The second-state changing step simultaneously changes the first item and the second item to the second state when both of the first item and the second item have been changed to the first state. More specifically, the specific item (84c) includes the first item and the second item that have a predetermined relationship. The second-state changing step (S37) simultaneously changes the first item and the second item to the second state when both of the first item and the second item have been changed to the first state so that it is possible to develop a story according thereto. That is, it is possible to enhance a fascinating aspect of the game.

In another embodiment, the specific item includes a first item and a second item that have a predetermined relationship. The second-state changing step changes the first item to the second state after changing the second item to the second state when both of the first item and the second item have been changed to the first state. More specifically, the second-state changing step (S61, S79) changes the second item to the second state prior to the first item when both of the first item and the second item have been changed to the first state, and thereafter, changes the first item to the second state so that it is also possible to develop a story according thereto. That is, it is possible to enhance a level of difficulties of the game, and a fascinating aspect of the game.

A game apparatus according to the present invention is provided with an operating means for inputting operating information by a player, a program storing means that stores a game program, a program processing means for reading out and processing the game program in correspondence with the operating information, and a display means for displaying a processing result of the game program as a game image. The game apparatus further comprises an elapsed time-period counting means, a player actionable time-period setting means, an item storing means, a comparing means, an action restraining means, and an actionable time-period changing means. The elapsed time-period counting means counts an elapsed time-period in a virtual space of a game play. The player actionable time-period setting means sets an actionable time-period of a player character. The item storing means stores an item possessed by the player character. The comparing means compares the actionable time-period set by the player actionable time-period setting means and the elapsed time-period counted by the elapsed time-period counting means. The action restraining means disables an action of the player character when the elapsed time-period setting exceeds the actionable time-period. Furthermore, the actionable time-period changing means changes the actionable time-period. This actionable time-period changing means increases the actionable time-period when a specific item is temporarily stored in the item storing means.

In this game apparatus, too, similar to the above-described storing medium that stores a game program, it is possible to expand the action range of the player character without depending on the battle.

An action-range controlling method according to the present invention is an action-range controlling method of a game character of a game apparatus provided with an operating means for inputting operating information by a player, and facilitating a game by generating a game image corresponding to the operating information and displaying the game image on a display means, and comprises following steps of: (a) temporarily storing an item possessed by a player character; (b) counting an elapsed time-period in a virtual space of a game play; (c) setting an actionable time-period of the player character; (d) comparing the actionable time-period set by the step (c) and the elapsed time-period counted by said step (b); (e) restraining an action of the player character when the elapsed time-period exceeds the actionable time-period; and (f) changing the actionable time-period set by the step (c) in such a manner as to render longer when a specific item is temporarily stored by the step (a).

In this action-range controlling method of a game character, too, similar to the above-described storing medium that stores a game program, it is possible to expand the action range of the player character without depending on the battle.

The above-described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one example of a game system of the present invention;

FIG. 2 is a block diagram showing electric structure of a video game apparatus shown in the FIG. 1 embodiment;

FIG. 3 is an illustrative view showing a memory map of a main memory shown in FIG. 2;

FIG. 4 is an illustrative view showing one example of a game screen shown on a monitor shown in FIG. 1 and FIG. 2;

FIG. 5 is an illustrative view showing another example of the game screen shown on the monitor shown in FIG. 1 and FIG. 2;

FIG. 6 is a flowchart showing a game process of a CPU shown in FIG. 2;

FIG. 7 is a flowchart showing one portion of one example of a wishing-ball event process of the CPU shown in FIG. 2;

FIG. 8 is a flowchart showing another portion of one example of the wishing-ball event process of the CPU shown in FIG. 2;

FIG. 9 is a flowchart showing one portion of another example of the wishing-ball event process of the CPU shown in FIG. 2;

FIG. 10 is a flowchart showing one portion of the other example of the wishing-ball event process of the CPU shown in FIG. 2; and

FIG. 11 is a flowchart showing another portion of the other example of the wishing-ball event process of the CPU shown in FIG. 2.

### DETAILED DESCRIPTION OF THE PREFERRED EMBODIMENTS

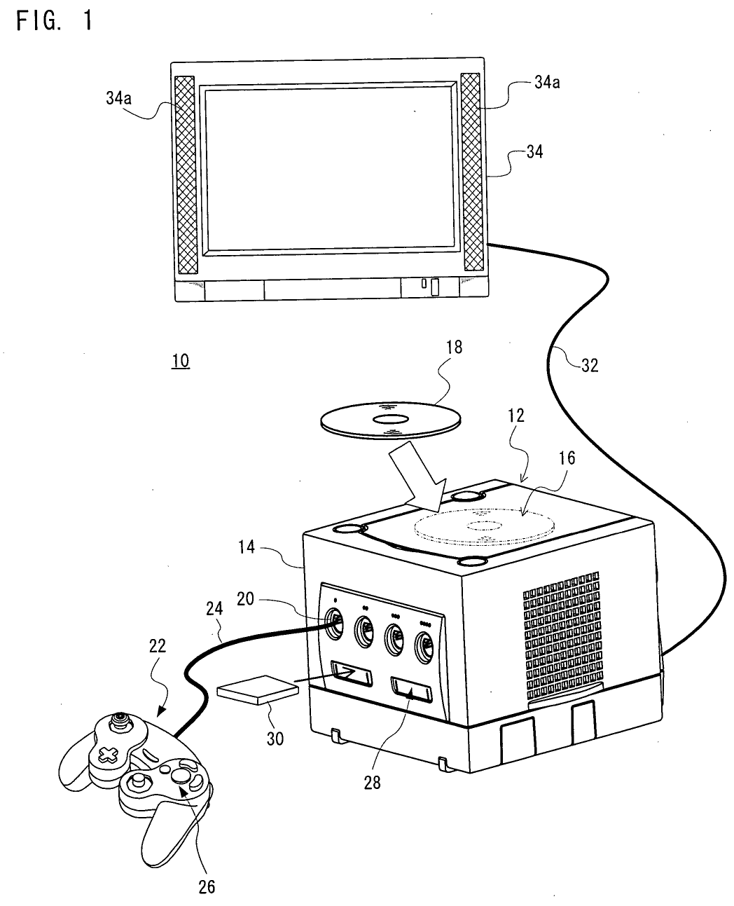

Referring to FIG. 1, a video game system 10 of this embodiment includes a video game apparatus 12. A power is supplied to this video game apparatus 12, and this power may be an ordinary AC adaptor (not shown) in the embodiment. The AC adaptor is inserted into a home-use conventional wall outlet, and converts a home-use power into a low DC voltage signal appropriate for driving the video game apparatus 12. In another embodiment, a battery may be used as the power.

The video game apparatus 12 includes an approximately cubic housing 14, and at an upper end of the housing 14, an optical disk drive 16 is provided. In the optical disk drive 16, an optical disk 18, which is one example of an information storing medium that stores a game program, and etc., is attached. At a front surface of the housing 14, a plurality of (4 in this embodiment) connectors 20 are provided. These connectors 20 are connectors for connecting a controller 22 to the video game apparatus 12 by a cable 24 provided to be integrated with the controller 22, and in this embodiment, it is possible to connect a maximum of four controllers 22 to the video game apparatus 12.

In the controller 22, an operating means (control) 26 is provided at its upper, lower, side surfaces, and etc. The operating means 26 includes two analog joysticks, one cross key, a plurality of button switches, and etc., for example. One analog joystick is used for inputting a moving direction and/or a moving speed or a moving amount of the player character (moving image character operable by the player using the controller 22) by a slanting amount and a direction of the stick. Another analog joystick controls by a slanting direction a movement of a virtual camera. The cross switch is used for instructing the moving direction of the player character in place of the analog joystick. The button switch is used for instructing the movement of the player character, changing a viewpoint of the virtual camera of a three-dimensional image, adjusting the moving speed of the player character, and so forth. Furthermore, the button switch controls a menu selection, and a pointer or a cursor movement, for example.

It is noted that in this embodiment, the controller 22 is connected to the video game apparatus 12 by the cable 24 being integrated therewith. However, the controller 22 may be connected to the video game apparatus 12 by another method such as in a wireless manner via an electromagnetic wave (radio wave or infrared ray, for example). In addition, needless to say, specific structure of the operating means of the controller 22 is not limited to the structure of the embodiment, and an arbitrary deformation is possible. One analog joystick may be sufficient, or may not be used at all, for example. The cross switch may not be used.

Below the connector 20 at the front surface of the housing 14 of the video game apparatus 12, at least one (2 in this embodiment) memory slot 28 is provided. A memory card 30 is inserted into this memory slot 28. The memory card 30 is used for loading and temporarily storing a game program, and etc., read out from the optical disk 18, saving game data (result of the game, for example) of the game played using this game system 10, and so forth.

At a rear surface of the housing 14 of the video game apparatus 12, an AV cable connector (not shown) is provided, and using the connector, a monitor 34 is connected to the video game apparatus 12 through an AV cable 32. Typically, the monitor 34 is a color television receiver, and the AV cable 32 inputs a video signal from the video game apparatus 12 to a video input terminal of the color television, and applies a sound signal to a sound input terminal. Therefore, a game image of a three-dimensional (3D) video game is displayed on the color television (monitor) 34, and a game sound (stereo game sound) such as a game music, a sound effect, and etc., is output from speakers 34a on both sides, for example.

In this game system 10, in order for a user or a game player to play the game (or another application), the player, first, turns on the power of the video game apparatus 12, next, the player selects the appropriate optical disk 18 that stores a video game (or another application intended to play) software, and loads the optical disk 18 into the disk drive 16 of the game apparatus 12. In response, the player allows the game apparatus 12 to start executing the video game or another application based on the software stored in the optical disk 18. The player operates the controller 22 in order to apply an input to the game apparatus 12. The player starts the game or another application by operating one of features of the operating means 26, for example. It is possible to move the moving image character (player character) to a different direction or change a viewpoint (camera location) of the player in a three-dimensional (3D) virtual space of the game play (hereinafter referred to as “game world”).

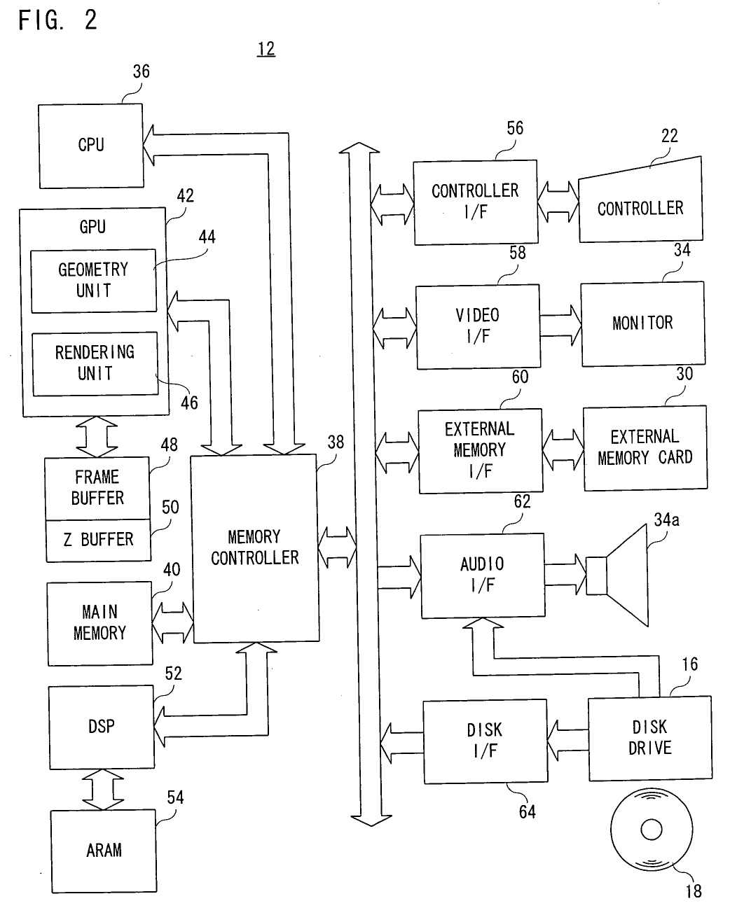

FIG. 2 is a block diagram showing electric structure of the video game system 10 of the FIG. 1 embodiment. In the video game apparatus 12, a central processing unit (hereinafter briefly referred to as “CPU”) 36 is provided. The CPU 36 is also called as a computer or a processor, and etc., and responsible for entirely controlling the video game apparatus 12. The CPU 36 or computer functions as a game processor, and the memory controller 38 is joined to this CPU 36 via a bus. Primarily, the memory controller 38 controls a writing or a reading-out of the main memory 40 joined via the bus under the control of the CPU 36. To this memory controller 38, a GPU (Graphics Processing Unit) 42 is joined.

The GPU 42 forms one portion of a rendering means, is constructed of a single chip ASIC, for example, and receives a graphics command (rendering instruction) from the CPU 36 via the memory controller 38 so as to generate a three-dimensional (3D) game image by a geometric unit 44 and a rendering unit 46 according to that command. That is, the geometric unit 44 performs coordinate operation processes such as a rotation, a movement, a deformation, and etc., of various characters and objects in a three-dimensional coordinate system (constructed of a plurality of polygons. In addition, the polygon is a polygonal plain surface defined by at least three vertex coordinates). The rendering unit 46 applies an image generating process such as attaching a texture (texture image) to each polygon of the various objects, and so forth. Therefore, the 3D image data to be displayed on the game screen is generated (created) by the GPU 42, and the image data is rendered (stored) within a frame buffer 48.

It is noted that the data (primitive or polygon or texture, and etc.) necessary for the GPU 42 to execute the rendering command is obtained by the GPU 42 from the main memory 40 via the memory controller 38.

The frame buffer 48 is a memory for rendering (accumulating) the image data worth 1 frame of a luster scanning monitor 34, and overwritten by the GPU 42 by each 1 frame, for example. As a result of a video I/F 58 described later reading out the data of the frame buffer 48 via the memory controller 38, the 3D game image is displayed on the screen of the monitor 34.

In addition, a Z buffer 50 has a storing capacity equal to the number of bits of depth data per the number of pixels (storing location or address) corresponding to the frame buffer 48 X one pixel, and stores depth information or the depth data (Z value) of dots corresponding to each storing location of the frame buffer 48.

It is noted that both of the frame buffer 48 and the Z buffer 50 may be constructed using one portion of the main memory 40.

The memory controller 38 is also joined to an ARAM 54 via a DSP (Digital Signal Processor) 52. Therefore, the memory controller 38 controls not only the main memory 40 but also the writing and/or reading-out of the ARAM 54 as a sub memory under the control of the CPU 36.

The DSP 52 works as a sound processor, and generates audio data corresponding to a sound, voices, or a music necessary for the game by using the sound data (not shown) stored in the main memory 40, using sound waveform data (not shown) written in the ARAM 54, and so forth.

Furthermore, the memory controller 38 is joined to each interface (IJF) 56, 58, 60, 62, and 64 by the bus. The controller I/F 56 is an interface for the controller 22, and applies to the CPU 36 an operating signal or data of the operating means 26 of the controller 22 through the memory controller 38. The video I/F 58 accesses the frame buffer 48 so as to read out the image data created by the GPU 42, and applies to the monitor 34 the image signal or the image data (digital RGB pixel value) via the AV cable 32 (FIG. 1).

The external memory I/F 60 coordinates the memory card 30 (FIG. 1) inserted in the front surface of the game apparatus 12 with the memory controller 38. Thereby, it enables the CPU 36 to write the data into this memory card 30, or read out the data from the memory card 30 via the memory controller 38. The audio I/F 62 receives the audio data applied from the DSP 52 through the memory controller 38, or an audio stream read out from the optical disk 18, and applies to the speaker 34a of the monitor 34 the audio signal (sound signal) corresponding thereto.

Furthermore, the disk I/F 64 joins the disk drive 16 to the memory controller 38, and therefore, the CPU 36 controls the disk drive 16. Program data, the texture data, and etc., read out from the optical disk 18 by this disk drive 16 are written into the main memory 40 under the control of the CPU 36.

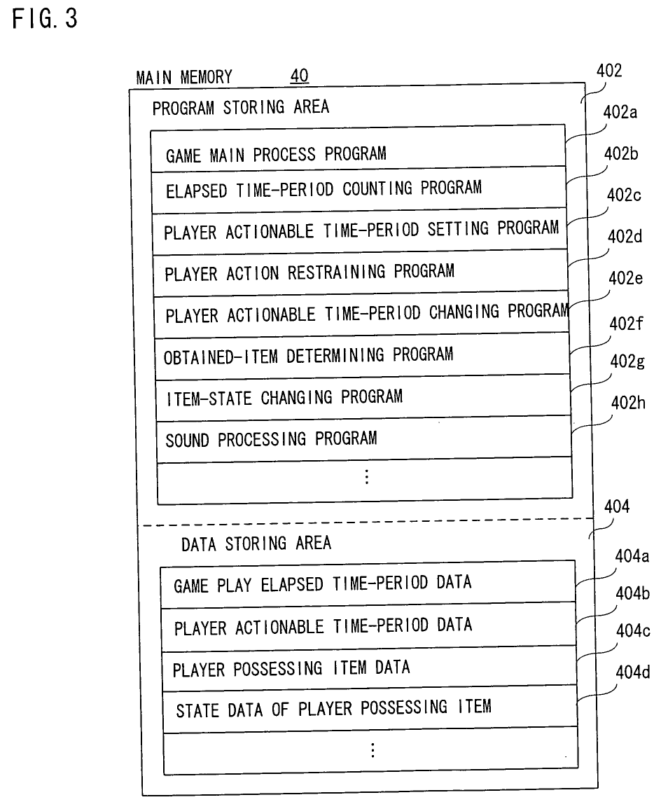

FIG. 3 shows a memory map of the main memory 40. The main memory 40 includes a program storing area 402, and a data storing area 404. In the program storing area 402, the game program read out from the optical disk 18 is stored at once or partially and sequentially. In this embodiment, the game program is constructed of a game main process program 402a, an elapsed time-period counting program 402b, a player actionable time-period setting program 402c, a player action restraining program 402d, a player actionable time-period changing program 402e, an obtained-item determining program 402f, and item-state changing program 402g, a sound processing program 402h, and etc.

Furthermore, in the data storing area 404, game play elapsed time-period data 404a, player actionable time-period data 404b, player possessing item data 404c, state data 404d of a player possessing item, and etc., are stored. The game play elapsed time-period data 404a is data of an elapsed time-period in the game world, that is, an actual time period (present time), and constructed of a timer (register) capable of registering (counting) per second a time period from an initial value (8:30, for example). The player actionable time-period data 404b is data regarding maximum (limit) time-periods during which the player character can act, out of time-periods in one day in the game world, and the time-period data is stored in the register.

In addition, in the player possessing item data 404c, data regarding the item obtained (possessed) by the player character is recorded. In this embodiment, the player possessing item data 404c is constructed of a plurality of bits of a register, and one item is allotted in such a manner as to correspond to each of the bits. Therefore, regarding the possessed item, a flag of the bit to which the item is allotted is turned on (data value=1), and regarding the item not possessed, the flag of the bit to which the item is allotted is turned off (data value=0).

Furthermore, the state data 404d of the player possessing item is data indicating a state of a specific item, out of the items possessed by the player character. The state data 404d of the player possessing item is constructed of a plurality of registers each of which corresponds to the specific item, for example. Each of the registers is constructed of three bits, and indicates the state of the corresponding specific items by its data value. More specifically, as described later, in a case of not obtaining the specific item, that is, a “wishing ball”, the data value of the register corresponding to the wishing ball is “000”. In addition, in a case of possessing the wishing ball, the data value of the register is “001”. Furthermore, in a case that the wishing ball is rendered a state capable of enclosing a wish, the data value of the register becomes “010”. Still furthermore, in a case that a wish is enclosed in the wishing ball, the data value of the register becomes “011”. Yet still furthermore, in a case that the wishing ball is changed to a wish-fulfilled ball, the data value of the register becomes “100”. Furthermore, in a case that the wish-fulfilled ball is dedicated to a shrine, and etc., the data value of the register becomes “101”.

It is noted that the data value of the register regarding such the specific item (wishing ball) is changed by the item-state changing program 402g shown in FIG. 3.

However, the state data 404d of the player possessing item may indicate the usable number of times regarding the item having a number-of-times limit (item of a medicine, an item of a technique or a magic, and etc). In this case, at every time that the item is obtained, the register corresponding to the item may be incremented, and to the contrary, at every time that the item is used, the register may be decremented. Therefore, in the item having such the number-of-times limit, the register may be constructed of four or more bits in order to be capable of counting a maximum value of the usable number of times.

Such the player possessing item data 404c and state data 404d of the player possessing item are stored, and thereby, it becomes possible to learn (administer) the item possessed by the player character and the state of specific item.

It is noted that regarding the specific item in which such the state data 404d of the player possessing item is stored, by the state data, it is possible to know whether there is the item, and therefore, its presence or absence may not be recorded in the player possessing item data 404c.

In addition, in the data storing area 404, the image data of a polygon, and etc., regarding a plurality of the characters, and the image data of the game world are stored. Herein, the character means the player character, a non-player character, an item character, a background object (character) such as a wall object or a ground-surface object, and etc. The player character is, as described above, a character that is made to move to a desired direction or execute a desired action by the player, and the non-player character is a character that moves to a direction determined by the program or executes an action determined by the program, without depending on a controller operation by the player. In addition, the item character is a character of items (food, money, medicine, wishing ball, wish-fulfilled ball, and etc.) obtained/possessed, and so forth, by the player character in the game.

Furthermore, in the data storing area 404, the sound data such as a sound, a music, voices, and etc., necessary for the game, and data of a game message appropriately displayed according to a proceeding of the game, and etc., are stored.

Generally, in many of so-called roll-playing games (hereinafter referred to as “RPG”), by making the player character operated by the player fight in a battle against an enemy character, an experience value is increased, as a result, the action range is expanded, or by defeating the enemy character of a specific level, the action range is expanded.

However, it is not possible for a player who finds difficulties in fighting in a battle (not good at fighting) to exactly perform an appropriate operation, and therefore, it is not possible to increase a physical value and the experience value of the player character, thus, not possible to expand the action range. Therefore, it is not possible to easily enjoy the RPG.

In order to avoid this problem, in this embodiment, an RPG with a new idea capable of expanding the action range without depending on the battle is provided, and thus, it is possible to easily enjoy the RPG.

To briefly describe the RPG in this embodiment, the RPG is a game in which a leading character (player character) existing on a certain island expands the actionable time-period, that is, the action range, by fulfilling a wish of a character (non-player character) of another person (islander), and et al., existing on the island, and achieves a predetermined final purpose by fulfilling the wish of various non-player characters.

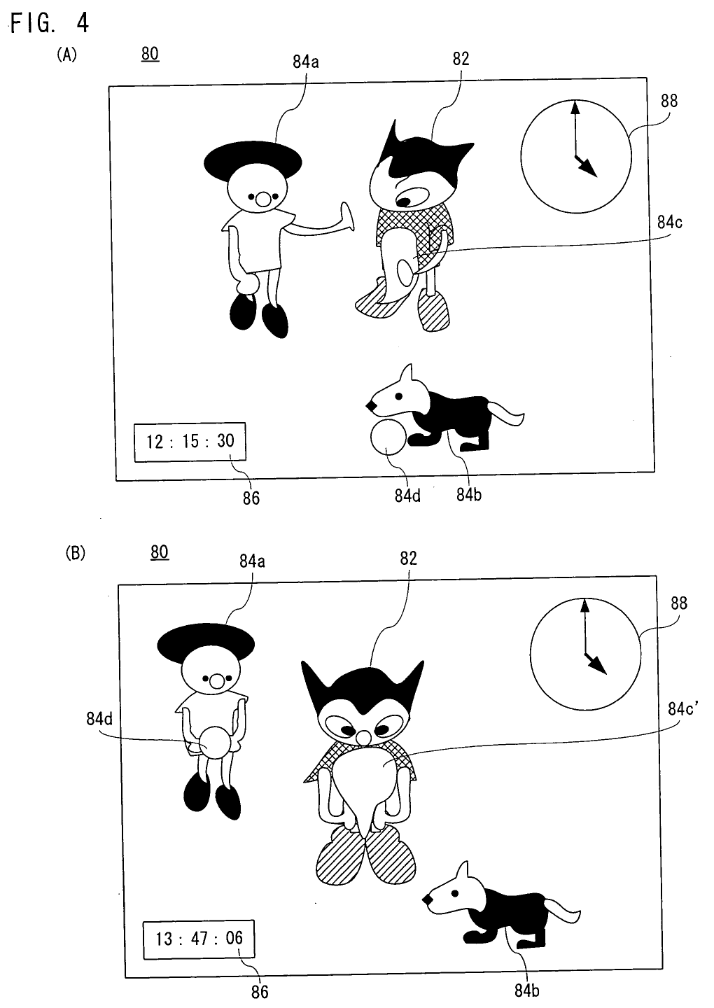

As shown in FIG. 4(A), one example of the game screen 80 of the RPG is displayed on the monitor 34, and on this game screen 80, the player character, that is, a leading character 82, a non-player character (islander) 84a, and a non-player character (dog) 84b are displayed. In addition, the present time in the game world (the island) is displayed in a displaying portion 86 at the lower left of the game screen 80. Furthermore, the actionable time-period of the leading character 82 in the game world is displayed in a displaying portion 88 at the upper right of the game screen 80.

It is noted that the present time is displayed in the display portion 86 according to the game play elapsed time-period data stored in the data storing area 404 of the main memory 40, and the actionable time-period is displayed in the displaying portion 88 according to the player actionable time-period data 404b stored in the same data storing area 404. Hereinafter, the same is applied in this embodiment.

In the example of this FIG. 4(A), a state, in which the leading character 82 possesses a wising ball 84c as the non-player character, and an islander 84a who is deprived of his ball 84d as the non-player character by a dog 84b requests (sends his wish) the leading character 82 to recover the ball 84d, is displayed. In addition, in the game world (island); it is displayed that the present time is 12:50:30, and the actionable time-period of the leading character 82 is 17:00.

Herein, the actionable time-period is, as described above, the maximum time-period during which the leading character 82 can act on the island, and if this actionable time-period is exceeded, the leading character 82 is forcefully brought back to his house (residence). Therefore, the action range is also limited. As described above, by fulfilling the wish of the islander 84a, and et al, this actionable time-period is extended, and therefore, the action range is also expanded. This will be specifically described by using Figures below.

FIG. 4(B) is a game screen 80 showing a state that the ball 84d is recovered from the dog 84b by the leading character 82. For the illustration's sake, it is not possible to express a color, and etc. However, the wishing ball 84c is changed to a wish-fulfilled ball 84c′. In addition, it is displayed that the present time on the island is 13:47:06, and the actionable time-period is 17:00.

It is noted that in order to fulfill the wish (in this case, a wish to recover the ball 84d of the islander 84a), it is necessary to enclose the wish into the wishing ball 84c, and until the wishing ball 84c is filled with the wish, the wish is not fulfilled. In this embodiment, until the wishing ball 84c is filled with the wish, the dog 84b merely barks “Bow wow” even when the leading character 84 talks to the dog 84b, and can not make a communication at all. However, if the wishing ball 84c is filled with the wish, the leading character 82 becomes capable of making a communication with the dog 84b, and the leading character 82 is capable of recovering the ball 84d from the dog 84b. Thus, when the leading character 82 fulfills the wish enclosed in the wishing ball 84c, the wishing ball 84c is changed to the wish-fulfilled ball 84c′.

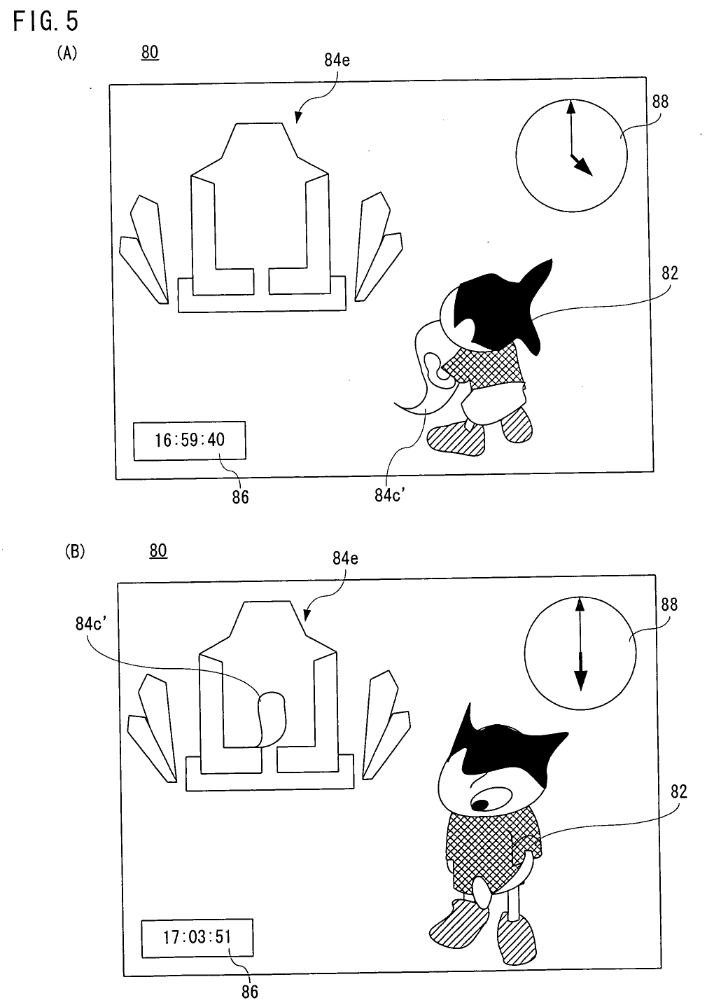

Next, according to the operation by the player, the leading character 82 moves to a place in which the wish-fulfilled ball 84c′ is dedicated. Then, the game screen 80 as shown in FIG. 5(A) is displayed. On the game screen 80, besides the leading character 82 possessing the wish-fulfilled ball 84c′, the displaying portion 86, and the displaying portion 88, a stone statue 84e as the non-player character is displayed. The leading character 82 dedicates the wish-fulfilled ball 84c′ to this stone statue 84e. Although not illustrated, the stone statue 84e is installed in the shrine, for example.

As shown in FIG. 5(B), if the leading character 82 dedicates the wish-fulfilled ball 84c′ to the stone statue 84e, that is, the shrine, the actionable time-period is extended (in this embodiment, 30 minutes is extended), the extended actionable time-period (18:00) is displayed on the displaying portion 88. Therefore, as described above, the action range is expanded.

It is noted that for the sake of simplicity, it is described that when the wishing ball 84c is changed to the wish-fulfilled ball 84c′, the wish-fulfilled ball 84c′ is immediately dedicated. However, a plurality of the wish-fulfilled balls 84c′ may be collectively dedicated. This is an item that the player can freely select.

Furthermore, for the sake of simplicity, it is described that when one wish-fulfilled ball 84c′ is dedicated, the actionable time-period is extended. However, there is a case that the actionable time-period is not extended unless the predetermined number, which is 2 or more, of the wish-fulfilled balls 84c′ is dedicated. This is an item set by a programmer, a designer (software designer), and et al., of this RPG.

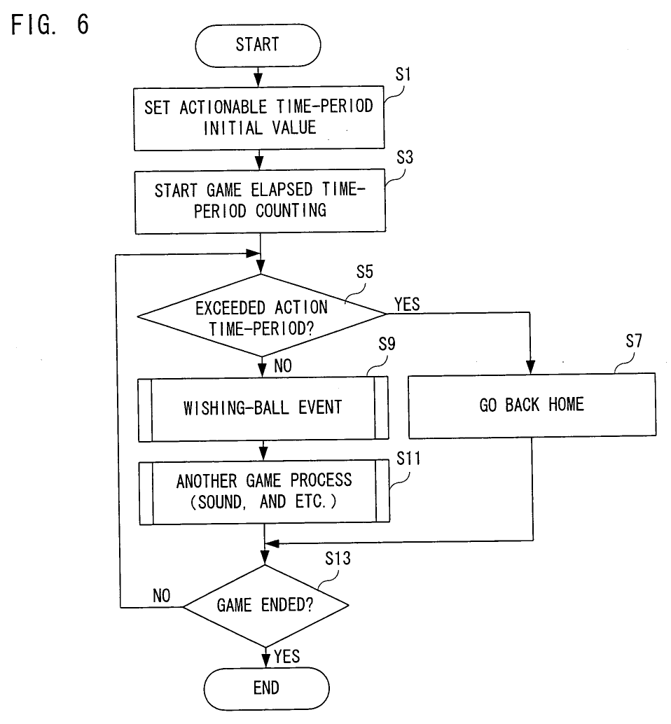

More specifically, the CPU 36 shown in FIG. 2 executes a process according to flowcharts shown in FIG. 6 to FIG. 8. When a game process of the RPG is started, an initial value of the actionable time-period (17:30:00, for example) is set in a step S1. That is, the CPU 36 reads out the player actionable time-period data stored in the data storing area 404 of the main memory 40, and sets the same. However, in a case of starting the game the player last played, backup data read out from the external memory card 30 is written into the data storing area 404 of the main memory 40 so that the player actionable time-period data included in the backup data is to be set.

In a succeeding step S3, counting a game elapsed time-period is started. That is, the present time is measured from the initial value (08:30:00). Then, in a step S5, it is determined whether or not the actionable time-period is exceeded. More specifically, the CPU 36 refers to the data storing area 404 of the main memory 40 so as to determine whether or not the game play elapsed time-period data 404a exceeds the player actionable time-period data 404b. If “YES” in the step S5, that is, if the present time exceeds the actionable time-period, the leading character 82 is brought back home in a step S7, and then, the process advances to a step S13. That is, in the step S7, irrespective of the operation by the player, and etc., the action of the leading character 82 is disabled, and the leading character 82 is brought back home.

On the other hand, if “NO” in the step S5, that is, if the present time does not exceed the actionable time-period, a wishing-ball event process described later is executed in a step S9, and in a step S11, another game process is executed. Then, the process advances to a step S13.

Although not described in detail, in another game process, a screen display process in which a character, and game screen corresponding to the operation of the player or a proceeding of the game are displayed is executed, a message display process in which a game message is displayed, an item managing (storing) process such as storing (managing) the item that the leading character 82 obtains, or storing (changing) a state of a specific item, and so forth., is executed, a sound process for outputting a sound (sound effect), a music (BGM), or voices, and etc., necessary for the game, a backup process in which the game data (backup data) is saved into the memory card 30 according to the instruction of the player, and etc., executed, and so forth.

In the step S13, it is determined whether or not the game is ended. That is, it is determined whether or not an instruction for ending the game is input by the player, or whether or not the game is over. If “NO” in the step S13, that is, unless the game is ended, the process directly returns to the step S5. On the other hand, if “YES” in the step S13, the game process is ended.

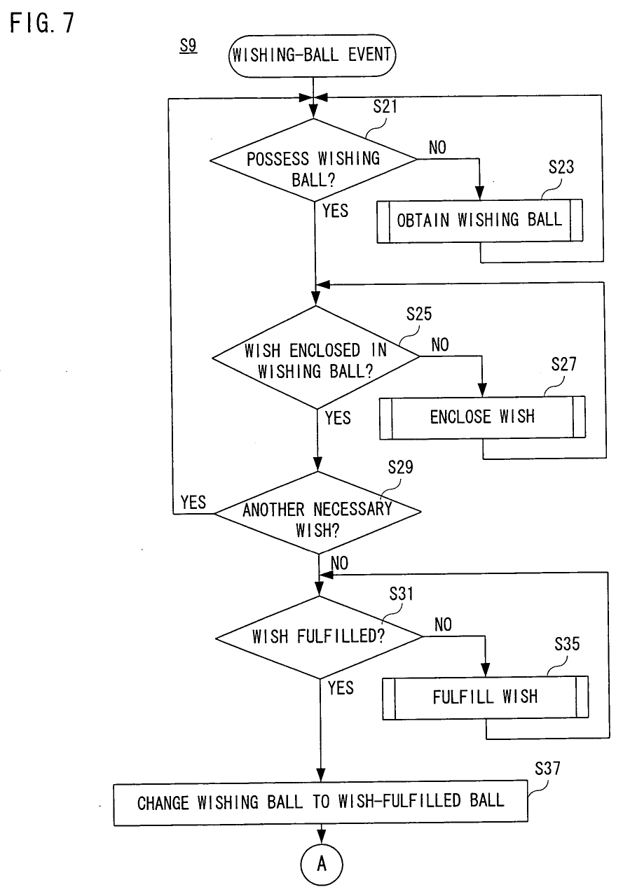

As described above, when the wishing-ball event process is started in the step S9, as shown in FIG. 7, it is determined whether or not the leading character 82 possesses the wishing ball 84c in a step S21. More specifically, the CPU 36 refers to the player possessing item data 404c or state data of the player possessing item (hereinafter briefly referred to as “state data”) 404d stored in the data storing area 404 of the main memory 40 so as to determine whether or not the leading character 82 possesses the wishing ball 84c.

If “YES” in the step S21, that is, if a register having a data value indicating “001” or “010” exists in the state data 404d, it is determined that the leading character 82 possesses the wishing ball 84c, and the process directly advances to a step S25. On the other hand, if “NO” in the step S21, that is, unless the register having the data value indicating “001” or “010” exists in the state data 404d, it is determined that the leading character 82 does not possess the wishing ball 84c, the process executes a wishing-ball obtaining process, and then, returns to the step S21. Although a detailed description is omitted, in the wishing-ball obtaining process, an action (behavior) of the leading character 82 is restrained according to the instruction of the player, and by offering a food, and etc., to the stone statue 84e, that is, the shrine, in which the wishing ball is placed, the leading character 82 becomes capable of obtaining the wishing ball 84c. However, corresponding to an amount or a kind of the offered items, for example, it is determined whether or not capable of obtaining the wishing ball 84c.

In a step S25, it is determined whether or not the wish is enclosed in the wishing ball 84c, that is, whether or not the wishing ball 84c is filled with the wish. More specifically, the CPU 36 refers to the state data 404d so as to determine whether or not the wish is enclosed in the wishing ball 84c. If “YES” in the step S25, that is, if the register having the data value indicating “011” exists in the state data 404d, it is determined that the wish is enclosed in the wishing ball 84c, and the process directly advances to a step S29. On the other hand, if “NO” in the step S25, that is, if the register having the data value indicating “011” does not exist in the state data 404d, it is determined that the wish is not enclosed in the wishing ball 84c, the process executes a wish-enclosing process in a steps S27, and then, returns to the step S25.

Although not described in detail, in the wish-enclosing process, the action (behavior) of the leading character 82 is restrained according to the operation of the player, and the wishing ball 84c possessed by the leading character 82 is rendered a state of being capable of enclosing the wish. As shown in FIG. 4(A), in a case of granting the wish from the islander 84a who is deprived of the ball 84d by the dog 84b, for example, only a brief look at this scene allows to understand that the islander 84a has a problem, and the wish to recover the ball 84d so that in this case, even if a special event is not cleared, the wishing ball 84c is rendered the state of being capable of enclosing the wish. That is, the data value of the register indicating the state of the wishing ball 84 is rendered “010”. However, there is a case that when the leading character 82 clears the special event, the wishing ball 84c is rendered the state of being capable of enclosing the wish. There is a case that unless the leading character 82 makes a special greeting (conversation), or offers the specific item possessed by the leading character 82 to a certain islander, the islander does not convey the wish, for example. That is, as the game progresses, an arrangement for making it difficult to recognize whether or not the non-player object such as the islander has the wish is designed. If the wishing ball 84c is in the state of being capable of enclosing the wish, that is, the state of having the data value of the register “010”, and the leading character 82 is capable of granting the wish from the non-player object, in correspondence thereto, the wish is enclosed into the wishing ball 84c. When the wish is enclosed, the data value of the register becomes “011”.

In a succeeding step S29, it is determined whether or not there is another necessary wish. More specifically, the CPU 36 refers to the state data 404d so as to determine whether or not the wish is enclosed in all the necessary wishing balls 84c. This is performed because there is a case that it is necessary to fulfill a plurality of the wishes, and dedicate a plurality of the wish-fulfilled balls 84c′. There is a case that the wish is enclosed in a certain wishing ball 84c and another wishing ball 84c, and the wishes enclosed therein are fulfilled one by one or simultaneously, for example. In addition, there is a case that until the certain wishing ball 84c is changed to the wish-fulfilled ball 84c′, another wishing ball 84c needs to be changed to the wish-fulfilled ball 84c′. Thus, the player needs to think about a method or measures (strategy) for changing the wishing ball 84c to the wish-fulfilled ball 84c′.

If “YES” in the step S29, that is, unless one portion or all of the data value of the register regarding all the necessary wishing balls 84c is “011”, it is determined that there is another necessary wish, and the process returns to the step S21 so as to determine whether or not to possess another wishing ball 84c. On the other hand, if “NO” in the step S29, that is, all the data value of the register regarding all the necessary wishing balls 84c are “011”, it is determined that there is no another necessary wish, and it is determined that the wish is fulfilled in a step S31. However, in a case of possessing a plurality of the wishing balls 84c in which the wishes are enclosed, it is determined whether or not all these wishes are fulfilled.

If “YES” in the step S31, that is, if all the wishes are fulfilled, the process directly advances to a step S37. On the other hand, if “NO” in the step S31, that is, unless all the wishes are fulfilled, the process executes a wish-fulfilling process in a step S35, and then, returns to the step S31. That is, until all the wishes are fulfilled, the processes of the steps S31 and S35 are repeated. Although a detailed description is omitted, in the wish-fulfilling process, the action (behavior) of the leading character 82 is restrained according to the operation of the player, and the wish enclosed in the wishing ball 84c is fulfilled. In a case shown in FIG. 4 and FIG. 4(B), for example, by recovering the ball 84d by making a conversation with the dog 84b, the wish of the islander 84a is fulfilled. In addition, there is a case that by visiting a specific location so as to take a certain item, the wish is fulfilled. Thus, the wish of the islander, et al., varies, and this is an item set by a programmer or a (software) designer.

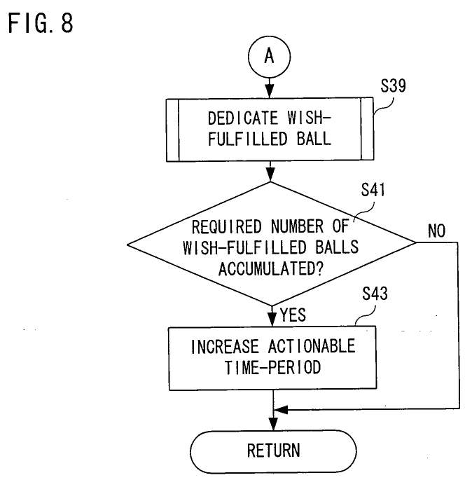

In the step S37, the wishing ball 84c is changed to the wish-fulfilled ball 84c′. At this time, the data value of the register regarding the wishing ball 84c having the wish fulfilled is changed to “100”. Next, in a step S39 shown in FIG. 8, a dedicating process of the wish-fulfilled ball 84c′ is executed. Although a detailed description is omitted, in the dedicated process, the action of the leading character 82 is restrained according to the operation of the player, as shown in FIG. 5(A) and Figure (B), the wish-fulfilled ball 84c′ is dedicated to the stone statue 84e in which the wishing ball 84c is obtained. At this time, the data value of the register regarding the dedicated wish-fulfilled ball 84c′ (wishing ball 84c) is changed to “101”.

In a succeeding step S41, it is determined whether or not the required number of the wish-fulfilled balls 84c′ is accumulated. More specifically, the CPU 36 refers to the state data 404d so as to determine whether or not the required number of the registers having the data value indicating “101” exists.

It is noted that as described later, in a case of extending the actionable time-period, if the data value of the register regarding the wish-fulfilled ball 84c′ dedicated prior thereto is to be changed to “111”, the determination in the step S41 is never to be erroneously made.

If “NO” in the step S41, that is, unless the required number of the registers having the data value indicating “101” exists, it is determined that the required number of the wish-fulfilled balls 84c′ is not accumulated, and the process directly returns the wishing-ball event process. On the other hand, if “YES” in the step S41, that is, if the required number of the registers having the data value indicating “101” exists, it is determined that the required number of the wish-fulfilled balls 84c′ is accumulated, as shown in FIG. 5(B) in the step S43, the actionable time-period is increased (extended), that is, by expanding the action range, the wishing-ball event process is returned.

It is noted even during a time that the wishing-ball event process is being executed, the present time is registered concurrent therewith so that in a case that the present time exceeds the actionable time-period, even during a time that the wishing-ball event process is being executed, the leading character 82 is mandatory brought back home.

Furthermore, although not illustrated, during a time that the wishing-ball obtaining process (S23), the wish-enclosing process (S27), the wish-fulfilling process (S35), and the wish-dedicating process (S39) are executed, too, another game process (S11) described above is executed.

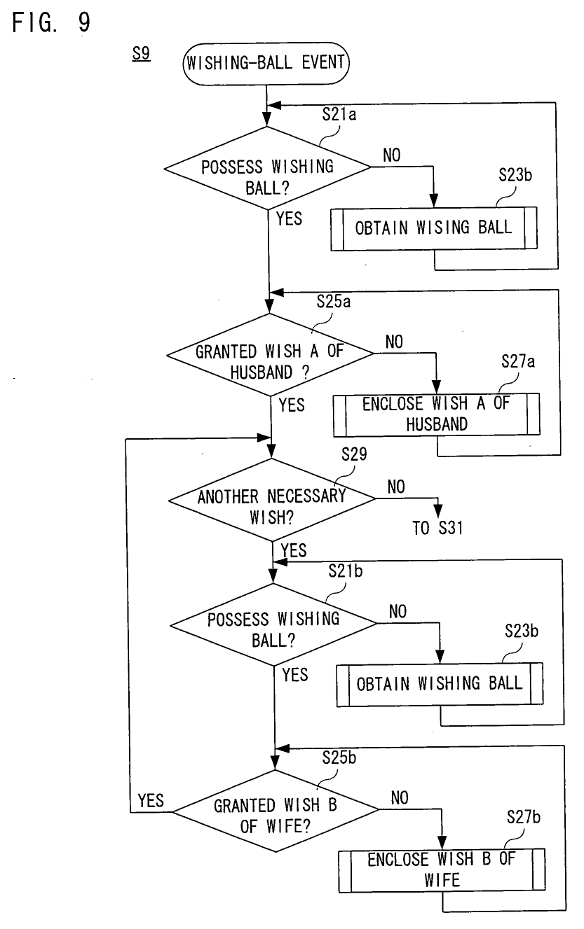

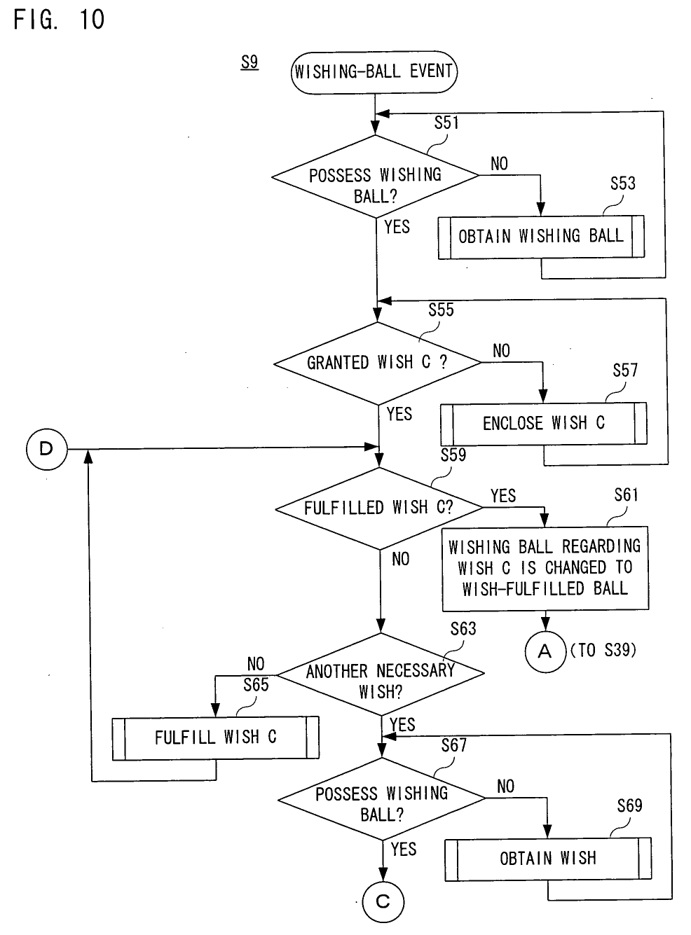

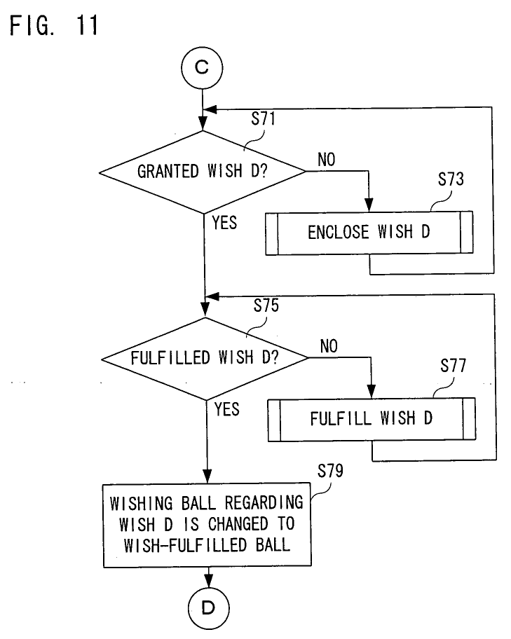

Next, the wishing-ball event process (S9) regarding a case of fulfilling a plurality (two) of the wishes is specifically described. Herein, descriptions will be made regarding a case of fulfilling the two wishes are simultaneously fulfilled (FIG. 9), and a case that it is necessary to fulfill another wish during a time that until one wish is fulfilled (FIG. 10 and FIG. 11).

A case of fulfilling the two wishes simultaneously may include a case of fulfilling a wish A in which a husband (certain islander 84a) who became a ghost wishes to meet his wife (another islander 84a), and a wish B in which the wife wishes to meet her husband. Herein, a description regarding this case will be given.

It is noted that in a case that the husband (certain islander 84a) who became the ghost unilaterally wishes to meet the wife (another islander 84a), the leading character 82 finds the wife, and then, it becomes possible to fulfill only the wish A of the husband who became the ghost.

FIG. 9 is a flowchart having one portion shown in FIG. 7 and FIG. 8 changed for simply describing the case that the wish A and the wish B are simultaneously fulfilled. However, this is essentially the same as the flowchart shown in FIG. 7 and FIG. 8. Therefore, in FIG. 9, the same reference numerals as in the steps shown in the wishing-ball event process shown in FIG. 7 and FIG. 8, or the reference numerals associated therewith are added. It is noted that a description of the steps regarding the same process content will be simplified.

As shown in FIG. 9, when starting the wishing-ball event process, in a step S21a, it is determined whether or not the leading character 82 possesses the wishing ball 84c. If “NO” in the step S21a, that is, unless possessing the wishing ball 84c, the process executes the wishing-ball obtaining process in a step S23a, and then, returns to the step S21a.

On the other hand, if “YES” in the step S21a, that is, if possessing the wishing ball 84c, it is determined whether or not the wish A of the husband is granted, that is, whether or not the wish A in which the husband, that is, the ghost, wishes to meet the wife is enclosed in a step S25a. If “NO” in the step S25a, that is, if the wish A of the husband is not enclosed in the wishing ball 84c, in a step S27a, the process executes an enclosing process of the wish A of the husband, and then, returns to the step S25a. On the other hand, if “YES” in the step S25a, that is, the wish A of the husband is enclosed in the wishing ball 84c, it is determined whether or not there is another wish in the step S29.

Herein, since there are the wish A and the wish B, “YES” is determined in the step S29, and the process advances to a step S21b. However, in a case that only one wish exists, or that all the wishes are granted (herein, in a case that the wish B of the wife is also granted) described later, as described above, “NO” is determined in the step S29, and the process move to a step S31 as shown in FIG. 7.

It is noted that the process of moving to the step S31 is the same as the above-described process so that its illustration is omitted.

In the step S21b, it is determined whether or not the leading character 82 possesses the wishing ball 84c. That is, it is determined whether or not possessing the wishing ball 84c for enclosing the wish B. If “NO” in the step S21b, that is, unless possessing the wishing ball 84c for enclosing the wish B, the process executes the wishing-ball obtaining process in a step S23b, and then, returns to the step S21b.

On the other hand, if “YES” in the step S21b, that is, possessing the wishing ball 84c for enclosing the wish B, it is determined whether or not the wish B is granted, that is, the wish B in which the wife wishes to meet the husband, that is, the ghost, is enclosed in a step S25b. If “NO” in the step S25b, that is, unless the wish B is enclosed, the process executes the enclosing process of the wish B of the wife in a step S27b, and then, returns to the step S25b. On the other hand, if “YES” in the step S25b, that is, if the wish B is enclosed, the process returns to the step S29.

Thus, if each of the wish A or the wish B is enclosed in the wishing ball 84c, a state in which the husband, that is, the ghost, and the wife can meet is established. The husband, that is, the ghost, temporarily appears before the wife, for example. Therefore, it is possible to simultaneously fulfill the wish A of the husband and the wish B of the wife, and the two wishing balls 84c are simultaneously changed to the wish-fulfilled ball 84c′ (S37).

In addition, a description regarding a case that another wish D needs to be fulfilled until one wish C is fulfilled will be given. That is, in a case of fulfilling the wish C of wishing to exchange (sold) jewelry to money from a certain islander 84a, there is a case that another islander 84a who wishes to buy the jewelry does not possess the money at this time, and therefore, he needs to fulfill the wish D of going to a secret place to take the money (secret savings).

It is noted that in a case that the islander 84a who wishes to buy the jewelry possesses the money, the leading character 82 exchanges the jewelry and the money, and delivers the exchanged money to the islander 84a who conveyed the wish C to the leading character 82s so that only the wish C is fulfilled.

Specific processes will be shown in FIG. 10 and FIG. 11, and the process shown in FIG. 7 (processes from the step S21 to the step S37) is different, out of the wishing-ball event processes shown in FIG. 7 and FIG. 8. Therefore, the description will be made by adding different reference numerals. However, regarding the steps of the same process content, the description will be simplified.

As shown in FIG. 10, when starting the wishing-ball event process, it is determined whether or not the leading character 82 possesses the wishing ball 84c in a step S51. If “NO” in the step S51, that is, unless possessing the wising ball 84c, the process executes the wishing-ball obtaining process in a step S53, and then, returns to the step S51.

On the other hand, if “YES” in the step S51, that is, possessing the wishing ball 84c, it is determined whether or not the wish C of the certain islander 84a is granted in a step S55. That is, it is determined whether or not the wish C that the certain islander 84a wishes to exchange the jewelry to the money is enclosed in the wishing ball 84c. If “NO” in the step S55, that is, unless enclosing the wish C in the wishing ball 84c, the process executes the enclosing process of the wish C in a step S57, and then, returns to the step S55.

On the other hand, if “YES” in the step S55, that is, if enclosing the wish C in the wishing ball 84c, it is determined whether or not the wish C is fulfilled in a step S59. If “YES” in the step S59, that is, if the wish C is fulfilled, the wishing ball 84c in which the wish C is enclosed is changed to the wish-fulfilled ball 84c′ in a step S61, and the process moves to the dedicating process of the wish-fulfilled ball 84c′ as shown in FIG. 8.

If “NO” in the step S59, that is, unless the wish C is fulfilled, it is determined whether or not there is another necessary wish in a step S63. Herein, there is a wish D necessary until the wish C is fulfilled so that “YES” is determined in the step S63, and therefore, the process advances to a step S67. However, in a case that only one wish exists, or that another wish (herein, the wish D) is fulfilled as described later, the process executes the process of fulfilling the wish C in a step S65, and then, returns to the step S59. In the process of fulfilling the wish C, according to the operation of the player, the action of the leading character 82 is restrained, and the leading character 82 goes to a place of the islander 84a who conveyed the wish C with the money obtained as a result of being exchanged to the jewelry.

In the step S67, it is determined whether or not the leading character 82 possesses the wishing ball 84c for enclosing the wish D. If “NO” in the step S67, that is, unless possessing the wishing ball 84c for enclosing the wish D, the process executes the wishing-ball obtaining process in a step S69, and then, returns to the step S67. On the other hand, if “YES” in the step S67, that is, if possessing the wishing ball 84c for enclosing the wish D, it is determined whether or not granting the wish D, that is, whether or not the wish D wishing to go to the secret place to take the money is enclosed in the wishing ball 84c in a step S71 shown in FIG. 11.

If “NO” in the step S71, that is, unless the wish D is enclosed, the process executes the enclosing process of the wish D in a step S73, and then, returns to the step S71. On the other hand, if “YES” in the step S71, that is, if the wish D is enclosed, it is determined whether or not the wish D is fulfilled in a step S75.

If “NO” in the step S75, that is, unless the wish D is fulfilled, the process executes the wish-fulfilling process of the wish D in a step S77, and then, returns to the step S75. In the wish-fulfilling process of the wish D, according to the operation of the player, the action of the leading character 82 is controlled, the leading character 82 goes to the secret place of the money so as to obtain the money, and thereafter, returns to the place of the islander 84a who conveyed the wish D.

On the other hand, if “YES” in the step S75, that is, if the wish D is fulfilled, the process changes the wishing ball 84c regarding the wish D to the wish-fulfilled ball 84c′ in a step S79, and returns to the step S59 shown in FIG. 10.

As described above, it is possible to fulfill a plurality of necessary wishes one by one, simultaneously fulfill a plurality of wishes, fulfill a plurality of wishes in the order of necessity, and so forth. That is, corresponding to a story of the game executed by the game main process program 402a, the CPU 36 selectively executes one of the wishing-ball event process described by using FIG. 9 (FIG. 7 and FIG. 8), and the wishing-ball event process described by using FIG. 10 and FIG. 11. In other words, it is possible to develop the story corresponding to any one of the wishing-ball event processes.

According to this embodiment, by fulfilling the wish of the islander, et al., that is, by changing the wishing ball to the wish-fulfilled ball and dedicating the wish-fulfilled ball, the actionable time-period is extended so that it is possible to expand the action range of the main player without depending on the battle. In addition, it is possible to improve the savor or amusement of the game not existed before, and enhance a thrill of overcoming the game.

It is noted that the game screen or the game content shown in this embodiment is merely an illustration, and not always the case. As another conceivable game content may include an RPG in which the leading character looks for a treasure (specific item) on a treasure island, and by extending the action range on an (one) island, extending the action range as a result of another islander being appeared, and so forth, in correspondence with a kind or the number of the obtained treasures, so that a predetermined object is finally fulfilled, for example. In addition, in this case, when the predetermined two or more treasures are obtained, a state of the treasure is changed (the predetermined two or more treasures are changed to another item necessary for a treasure-hunting such as a map of treasure, and each of the items is changed to another treasure, or each of them is assimilated, and changed to a (one) new treasure, and so forth, for example). If thus arranged, as in the above-described embodiments, it is also possible to extend the action range corresponding to the state data.

In addition, in this embodiment, the description is only made regarding the video game apparatus connected to the monitor. However, it is needless to say that the present invention is applicable to a game apparatus with which the monitor is integrated.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storing medium that stores a game program of a game apparatus provided with an operating means for inputting operating information by a player, and facilitating a game by generating a game image corresponding to the operating information and displaying the game image on a display means,
said game program allows a processor of said game apparatus to execute following steps of:
an item storing step for temporarily storing an item possessed by a player character;
an elapsed time-period counting step for counting an elapsed time-period in a virtual space of a game play;
an actionable time-period setting step for setting an actionable time-period of said player character;
a comparing step for comparing said actionable time-period set by said actionable time-period setting step and the elapsed time-period counted by said elapsed time-period counting step;
an action restraining step for restraining an action of said player character when said elapsed time-period exceeds said actionable time-period; and
an actionable time-period changing step for changing the actionable time-period set by said actionable time-period setting step in such a manner as to render longer when a specific item is temporarily stored by said item storing step.

2. A storing medium that stores a game program according to claim 1, wherein
said actionable time-period changing step increases said actionable time-period in correspondence with the number of specific items stored by said item storing step.

3. A storing medium that stores a game program according to claim 1, wherein
said item storing step includes an item-state storing step for temporarily storing item-state data indicating states of each of said items;
said actionable time-period changing step changes said actionable time-period in such a manner as to render longer when the item-state data of said specific item shows a predetermined state.

4. A storing medium that stores a game program according to claim 1, further comprising:
a first-state changing step for changing a state of said specific item to a first state; and a second-state changing step for changing to a second state said specific item that is changed to the first state when a predetermined condition is satisfied; wherein
said actionable time-period changing step changes said actionable time-period in such a manner as to render longer when said specific item is changed to said second state.

5. A storing medium that stores a game program according to claim 4, wherein
said specific item includes a first item and a second item that have a predetermined relationship, and
said second-state changing step simultaneously changes said first item and said second item to the second state when both of said first item and said second item have been changed to the first state.

6. A storing medium that stores a game program according to claim 4, wherein
said specific item includes a first item and a second item that have a predetermined relationship, and
said second-state changing step changes said first item to the second state after changing said second item to the second state when both of said first item and said second item have been changed to the first state.

7. A game apparatus provided with an operating means for inputting operating information by a player, a program storing means that stores a game program, a program processing means for reading out and processing said game program in correspondence with the operating information, and a display means for displaying a processing result of the game program as a game image, comprising:
an elapsed time-period counting means for counting an elapsed time-period in a virtual space of a game play;
an actionable time-period setting means for setting an actionable time-period of the player character;
an item storing means for temporarily storing an item possessed by said player character;
a comparing means for comparing the actionable time-period set by said actionable time-period setting means and the elapsed time-period counted by said elapsed time-period counting means;
an action restraining means for restraining an action of said player character when said elapsed time-period setting exceeds said actionable time-period; and
an actionable time-period changing means for changing the actionable time-period set by said actionable time-period setting means; wherein
said actionable time-period changing means changes said actionable time-period in such a manner as to render longer when a specific item is temporarily stored in said item storing means.

8. A game apparatus according to claim 7, wherein
said actionable time-period changing means increases said actionable time-period in correspondence with the number of specific items stored by said item storing means.

9. A game apparatus according to claim 7, wherein
said item storing means includes an item-state storing means for temporarily storing item-state data showing states of each of said items; and
said actionable time-period changing means changes said actionable time-period in such a manner as to render longer when the item-state data of said specific item shows a predetermined state.

10. A game apparatus according to claim 7, further comprising:
a first-state changing means for changing a state of said specific item to a first state, and a second-state changing means for changing to a second state said specific item that is changed to the first state when a predetermined condition is satisfied; wherein
said actionable time-period changing means changes said actionable time-period in such a manner as to render longer when said specific item is changed to said second state.

11. A game apparatus according to claim 10, wherein
said specific item includes a first item and a second item that have a predetermined relationship; and
said second-state changing means simultaneously changes said first item and said second item to the second state when both of said first item and said second item have been changed to the first state.

12. A game apparatus according to claim 10, wherein
said specific item includes a first item and a second item that have a predetermined relationship, and
said second-state changing means changes said first item to the second state after changing said second item to the second state when both of said first item and said second item have been changed to the first state.

13. An action-range controlling method of a game character of a game apparatus provided with an operating means for inputting operating information by a player, and facilitating a game by generating a game image corresponding to the operating information and displaying the game image on a display means, comprising following steps of:
(a) temporarily storing an item possessed by a player character;
(b) counting an elapsed time-period in a virtual space of a game play;
(c) setting an actionable time-period of said player character;
(d) comparing said actionable time-period set by said step (c) and the elapsed time-period counted by said step (b);
(e) restraining an action of said player character when said elapsed time-period exceeds said actionable time-period; and
(f) changing the actionable time-period set by said step (c) in such a manner as to render longer when a specific item is temporarily stored by said step (a).

14. A action-range controlling method of a game character according to claim 13, wherein
said step (f) increases said actionable time-period in correspondence with the number of specific items stored by said step (a).

15. An action-range controlling method of a game character according to claim 13, wherein
said step (a) includes a step (a-1) for temporarily storing item-state data showing states of each of said items; and
said step (f) changes said actionable time-period in such a manner as to render longer when the item-state data of said specific item shows a predetermined state.

16. An action-range controlling method of a game character according to claim 15, further comprising:
a step (g) for changing a state of said specific item to a first state; and a step (h) for changing to a second state said specific item that is changed to the first state when a predetermined condition is satisfied; wherein
said step (f) changes said actionable time-period in such a manner as to render longer when said specific item is changed to said second state.

17. An action-range controlling method of a game character according to claim 16, wherein
said specific item includes a first item and a second item that have a predetermined relationship, and
said step (h) simultaneously changes said first item and said second item to the second state when both of said first item and said second item have been changed to the first state.

18. An action-range controlling method of a game character according to claim 16, wherein
said specific item includes a first item and a second item that have a predetermined relationship, and
said step (h) changes said first item to the second state after changing said second item to the second state when both of said first item and said second item have been changed to the first state.
